(19) United States
(12) Patent Application Publication
(10) Pub. No.: US 2008/0289007 A1
(43) Pub. Date: Nov. 20, 2008

(54) System and Method for Granting Privileges Based on Location

(76) Inventor: Ajay MALIK, San Jose, CA (US)

Correspondence Address: FAY KAPLUN & MARCIN, LLP, 150 BROADWAY, SUITE 702, NEW YORK, NY, 10038, US

(21) Appl. No.: 11/876,504

(22) Filed: Oct. 22, 2007

Related U.S. Application Data
(60) Provisional application No. 60/938,567, filed on May 17, 2007.

(51) Int. Cl. H04L 9/32

(52) U.S. Cl. 726/4

(57) ABSTRACT

A method grants privileges based on location. The method comprises determining a location of a mobile unit disposed within a coverage area of a network. The coverage area is separated into a plurality of zones. The method comprises determining a first zone in which the mobile unit is disposed. The method comprises granting access to a first privilege to the mobile unit, the first privilege being based on the first zone.

### PRIORITY CLAIM

This application claims the priority to the U.S. Provisional Application Ser. No. 60/938,567, entitled “System and Method for Granting Privileges Based on Location,” filed May 17, 2007. The specification of the above-identified application is incorporated herewith by reference.

### FIELD OF THE INVENTION

The present invention relates generally to a system and method for granting privileges based on location. Specifically, when a mobile unit is disposed in a particular location, the mobile unit is granted a predetermined set of privileges.

### BACKGROUND INFORMATION

Conventionally, an access control list (ACL) is applied based on a media access control (MAC). A MAC is a part of a data link layer specified in the seven-layer Open Systems Interconnection (OSI) model. The MAC provides addressing and channel access control mechanisms that make it possible for several terminals or network nodes to communicate within a multipoint network such as a local area network (LAN) or metropolitan area network (MAN). However, the MAC functions independently of a location in which a mobile unit is present. Thus, the mobile unit may be granted privileges that are unnecessary, redundant, etc., thereby causing a waste of resources, an increased need for processing power, etc.

### SUMMARY OF THE INVENTION

The present invention relates to a system and method for granting privileges based on location. The method comprises determining a location of a mobile unit disposed within a coverage area of a network. The coverage area is separated into a plurality of zones. The method comprises determining a first zone in which the mobile unit is disposed. The method comprises granting access to a first privilege to the mobile unit, the first privilege being based on the first zone.

The system comprises a wireless switch including an access control list and a location engine. The system comprises a plurality of access points located in a facility and communicating with the wireless switch, the facility being separated into a plurality of zones. The system comprises at least one mobile unit disposed within a first zone of the facility, the mobile unit being granted access to a first privilege based on the first zone, the first privilege being determined by the access control list and the location engine, the access control list controlling a granting of the at least one privilege, the location engine determining the location of the mobile unit and associating the first privilege with the first zone.

### DESCRIPTION OF THE DRAWINGS

FIG. 1 shows a wireless switch according to an exemplary embodiment of the present invention.

FIG. 2 shows an exemplary network in which the wireless switch of FIG. 1 operates.

FIG. 3 shows a method using location as a basis for granting access to privileges according to an exemplary embodiment of the present invention.

FIG. 4 shows a spreadsheet for an access control list depending on a zone according to an exemplary embodiment of the present invention.

### DETAILED DESCRIPTION

The exemplary embodiments of the present invention may be further understood with reference to the following description and the appended drawings, wherein like elements are referred to with the same reference numerals. The exemplary embodiments of the present invention describe a system and method for granting access to privileges based on a location of a mobile unit (MU). According to the exemplary embodiments of the present invention, a location engine is accessed by an access control list (ACL) engine to determine the privileges that the MU may be granted. The location engine, ACL engine, and privileges will be discussed in more detail below.

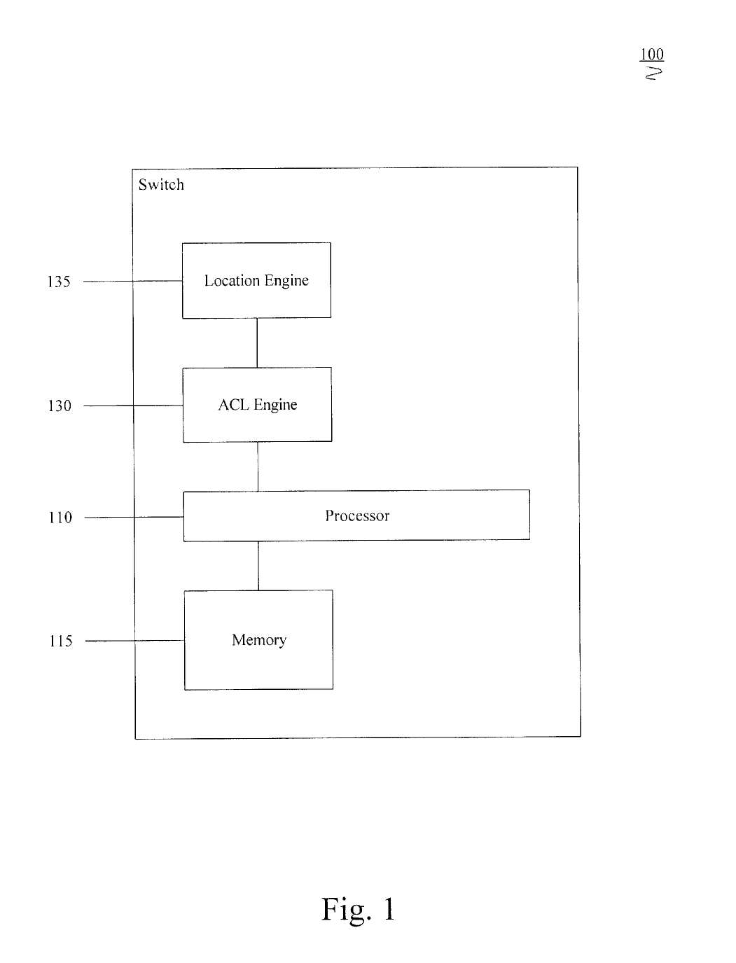

FIG. 1 shows a wireless switch 100 according to an exemplary embodiment of the present invention. The wireless switch 100 may be any networking device performing a transparent bridge at a maximum speed capability of the hardware. The wireless switch 100 may operate at half duplex (i.e., send or receive at any given time) or full duplex (i.e., send and receive at any given time). The wireless switch 100 may also operate at a variety of rates such as 10, 100, 1000 Mbps. It should be noted that the wireless switch 100 may have any combination of the above-described characteristics. The wireless switch 100 may include a processor 110, a memory 115, an ACL engine 130, and a location engine 135.

The processor 110 may be a central component that operates the wireless switch 100. The processor 110 may include conventional functionalities included in processors found in conventional wireless switches. The processor 110 may also include additional functionalities related to locations and ACLs, as will be discussed in further detail below. The wireless switch 100 may communicate with external thin access ports and/or access points. The access points may be equipped with at least a radio and antenna that facilitates communication with the MUs. The memory 115 may store data related to the wireless switch 100, include programs executed by the wireless switch 100, etc.

The ACL engine 130 may be a component or process that controls access to functionalities, data, etc. That is, the ACL may be a list of permissions attached to an object. The ACL may specify whether a mobile unit (MU) or user may access the object (e.g., data) and corresponding operations associated with the object (e.g., program). The ACL engine 130 may include the ACL that may be modifiable by an administrator. It should be noted that the ACL engine 130 disposed as a separate unit is only exemplary. For example, the ACL engine 130 may be a software program that may be stored on the memory 115 and executed by the processor 110.

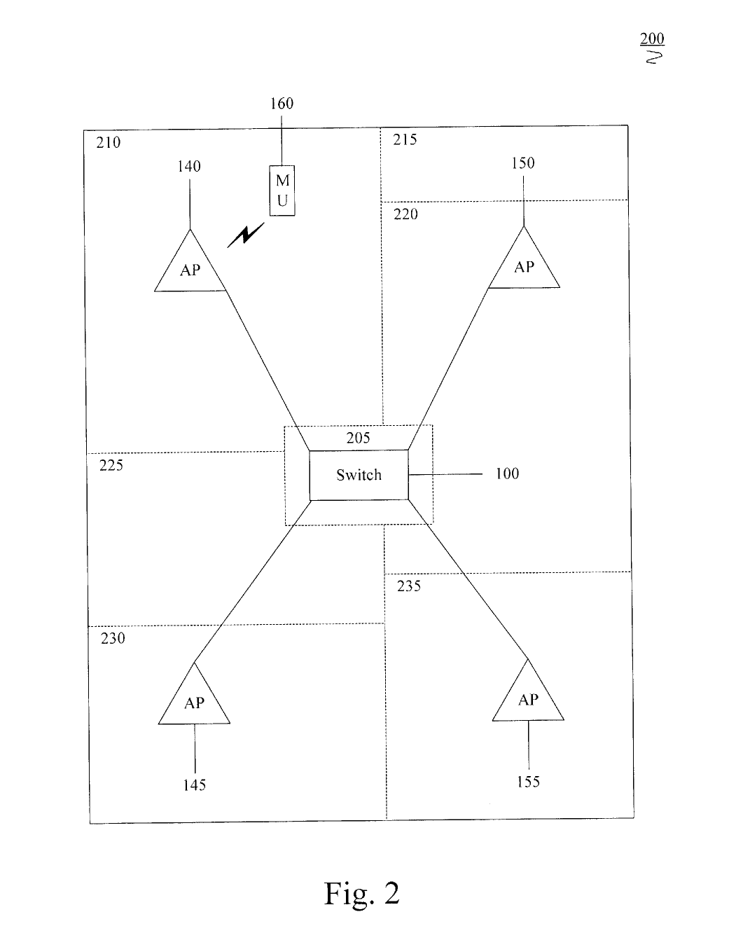

The location engine 135 is disposed within the wireless switch and may include a logical connection to the ACL engine 130. The location engine 135 may receive data and determine a location of mobile units (MU) within a wireless network based on the received data. The location engine 135 may also contain a list of accessible functionalities, data, etc. pertaining to various locations within a network. The location engine 135 will be further discussed with reference to FIG. 2. The location engine 135 being disposed within the wireless switch 100 allows a more efficient access to the data contained within the location engine 135 when the ACL engine 130 determines associated privileges with various locations. It should be noted that the location engine 135 disposed as a separate unit is only exemplary. For example, the location engine 135 may be a software program that may be stored on the memory 115 and executed by the processor 110.

FIG. 2 shows an exemplary wireless network 200 in which the wireless switch 100 of FIG. 1 operates. The network 200 may include the wireless switch 100 and a plurality of access points (AP) 140-155. As shown in FIG. 2, the APs 140-155 are disposed throughout the network 200. The AP is a network device that connects communication devices to extend a coverage for the network. For example, the network 200 may include the wireless switch 100 that includes a finite coverage area using a radio and antenna. Those skilled in the art will understand that when the radio and the antenna use a maximum power availability, a maximum coverage area may be had but is limited by the power and capabilities of the radio and the antenna. To extend the coverage area of the network 200, the APs 140-155 may be disposed at strategic locations to increase the coverage area of the network. The APs 140-155 may also include antennas and radios so that MUs may wirelessly connect to the network 200. FIG. 2 also shows an MU 160 that is wirelessly communicating with the AP 140. It should be noted that additional MUs may be disposed within the network and communicating with any of the APs (e.g., APs 145-155) and/or the wireless switch 100.

It should be noted that the APs 140-155 being hard-wired to the wireless switch 100 is only exemplary. According to the exemplary embodiments of the present invention, the APs 140-155 may also be connected to the wireless switch 100 wirelessly, i.e., the radio of the wireless switch 100 is used to communicate with the APs 140-155. It should also be noted that the use of APs 140-155 is only exemplary. Those skilled in the art will understand that depending on the size of a facility that utilizes the network 200, the capabilities of the radios and antennas associated with the APs, etc. more or fewer APs may be disposed to increase the coverage area of the network 200.

The network 200 may be divided into a plurality of zones. For example, according to the exemplary embodiment of the present invention, the network 200 includes zones 205-235. The zones may be, for example, physical locations within the facility in which the network 200 is deployed. A user of the system may define various zones (e.g., zones 205-235) in the facility based on the particular needs of the user. The zones 205-235 may be a part of the network that is covered by at least one AP. For example, zone 210 may be entirely covered by the AP 140. However, the zone 210 may also be partially covered by AP 150 (e.g., toward the side of zone 210 that abuts zones 215, 220). The zone 205 may specifically be created to hold the wireless switch 100. For example, the zone 205 may be an administrative office where the parameters of the network 200 are overseen by the administrator. It should be noted that the APs 140-155 being disposed within the zone confines of the zones 205-235 is only exemplary. Those skilled in the art will understand that additional APs may be disposed outside the zones 205-235 to provide a coverage area that is not covered by the APs 140-155.

The network 200 may encompass a variety of areas that utilize the network. For example, the network 200 may be used for a retail facility. Thus, the zones 205-235 may be different departments of the retail facility (e.g., zone 210 is a clothing department, zone 220 is an electronics department, zone 225 is a food department, etc.). In another example, the network 200 may be used for a warehouse facility. Thus, the zones 205-235 may be different storage areas of the warehouse facility (e.g., zone 210 houses electronic equipment, zone 225 houses fabrics, zone 230 houses tools, etc.). In another example, the facility may be a mixed use such as a warehouse portion and an executive office portion or a laboratory portion and a production portion, etc. It should be noted that the number of zones 205-235 is only exemplary. As discussed above, the number of zones may be dependent on the type of facility that utilizes the network 200. For example, a retail facility may require more zones depending on the number of departments. In another example, an office facility may require fewer zones depending on the number of groups and/or work departments.

The location engine 135 may associate the zones 205-235 with various privileges pertaining to the respective zone. For example, if the network 200 is a retail facility with the zones 205-235 representing different departments, the location engine 135 may include a list of privileges associated therewith. The MU 160 may be a personal shopping aid device that allows a user to query about a certain product such as a description of the product, a cost associated with the product, etc. If the zone 205 is an administrative office, the location engine 135 may allow an MU 160 located within zone 205 to access all data and programs available within the network 200. The data and programs may include, for example, administrative software, administrative data, etc. If the zone 220 is an electronics department, the location engine 135 may allow an MU disposed in zone 220 to access data related to the electronic equipment that is available for sale in that department. If the zone 215 includes adult-related material, the location engine 135 may allow an MU disposed in zone 215 to access data related to the adult-related material. The method for the location engine 135 in combination with the ACL engine 130 to provide the desired access will be described below.

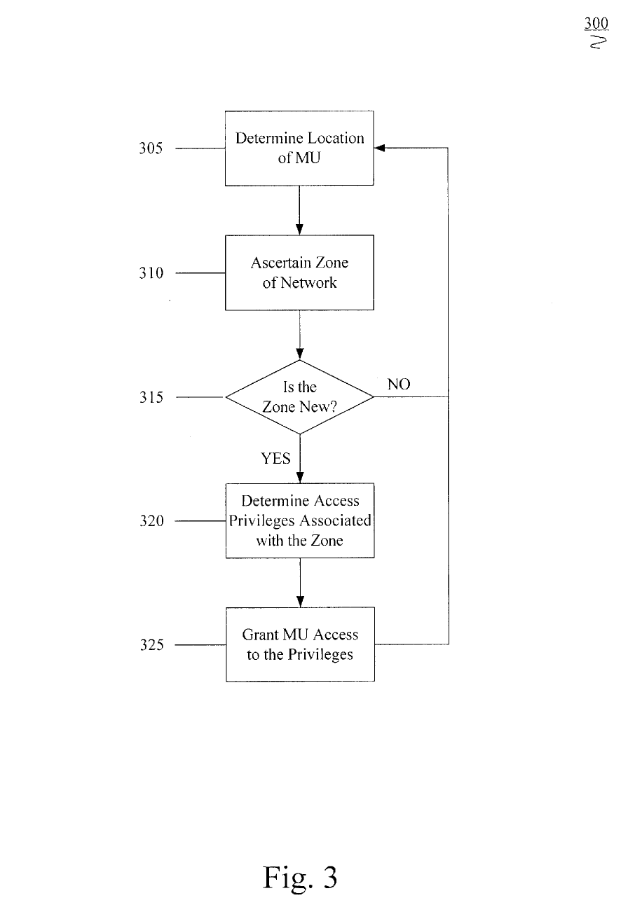

FIG. 3 shows a method 300 using location as a basis for granting access to privileges according to an exemplary embodiment of the present invention. The method 300 will be described with reference to the wireless switch 100 of FIG. 1 and the network 200 of FIG. 2. The method 300 utilizes the ACL engine 130 in tandem with the location engine 135 in order to determine the various privileges (e.g., data, software, etc.) granted to an MU disposed in a particular location within the network 200.

In step 305, the location of the MU is determined by the location engine 135. The location of the MU may be determined in a variety of methods. For example, each MU may include location determining software such as a global position system (GPS) that is then transmitted back to the wireless switch 100. In another example, a received signal strength indication (RSSI) may be used as a determinant of location. Using different RSSI from at least two APs, the location engine 135 may extrapolate the location of the MU within the network 200. Further examples of determining the location of the MU within the network 200 include smart surroundings, radio frequency identification (RFID), etc.

In step 310, a corresponding zone of the location of the MU is determined. The location of the MU may be referenced with a layout of the facility in which the network 200 is utilized. For example, if RSSI is used to extrapolate location, readings may indicate that a strong signal is received from the AP 140, a medium signal is received from the AP 150, a weak signal is received from the AP 145, and a weakest signal is received from the AP 155. A location is determined (e.g., step 305) that the MU is located somewhere in an upper left corner of the network 200. The corresponding zone of the location of the MU may be determined as being in zone 210. It should be noted that other methods of determining the zone in which the MU is located may be used including the other location determining methods described above. For example, the location engine 135 may include a database that relates positions to zones. When the position of the MU is determined in step 305, this position may then be translated to a zone using the database.

In step 315, a determination is made whether the zone that the MU is located is new. This determination may indicate whether to continue granting access to privileges associated with the location or grant access to other privileges associated with a different location. Thus, if step 315 determines that the MU is not in a new zone, the method 300 returns to step 305 to determine the location of the MU. Those skilled in the art will understand that this feedback continues to occur until the MU has moved into a different zone. If step 315 determines that the MU is in a new zone, then the method continues to step 320. It should be noted that if step 315 does not determine that the MU is in a new zone, the MU may continued to be granted privileges associated with the current zone. That is, the MU may remain in the current zone. Thus, the privileges associated with the current zone remain granted.

In step 320, access privileges associated with the zone are determined. As discussed above with the retail facility example, depending on the zone and the department that represents the zone, various privileges may be associated. The determination of accessible privileges may be done using the ACL engine 130 and the location engine 135. As discussed above, the ACL engine 130 includes the ACL. The location engine 135 also includes a list of privileges associated with a location. Thus, when the ACL engine 130 accesses the list of the location engine 135, the privileges associated with the location may be determined.

In step 325, the privileges are granted to the MU located in the zone. As discussed above with the retail facility example, the privileges may be tailored to the zone in which the MU is located. For example, if the MU is located in zone 205 representing an administrative office, the MU may be granted privileges to programs and data associated with maintaining the network 200. In another example, if the MU is located in zone 230 representing an electronics department, the MU may be granted privileges to data that includes descriptions, costs, etc. associated with various electronic equipment. Once the privileges associated with the zone have been granted, the method 300 returns to step 305 where the location of the MU is determined.

It should be noted that the method 300 assumes that the MU is already in the network and is granted a set of privileges associated with the zone in which the MU is located. However, the method 300 may also apply to newly entering MUs. That is, the method 300 may bypass step 315 for newly entering MUs. Furthermore, the method 300 assumes that the MU remains in the network. However, the method 300 may also apply to exiting MUs. That is, the method 300 may include an additional step that determines if the MU is no longer located in the network. Consequently, the method 300 may include a step that disables all privileges (e.g., software, data, etc.) to the MU that is no longer in the network.

Furthermore, it should be noted that the method 300 may include additional steps not shown in FIG. 3. For example, the zone 235 may represent a checkout area for the retail facility. In such an embodiment, the method 300 may include a step where if the MU enters the zone 235, access to privileges such as data relating to products may be disabled. Furthermore, access to a specific type of program (e.g., checkout software) may be granted so that the consumer may tally costs and exit the retail facility.

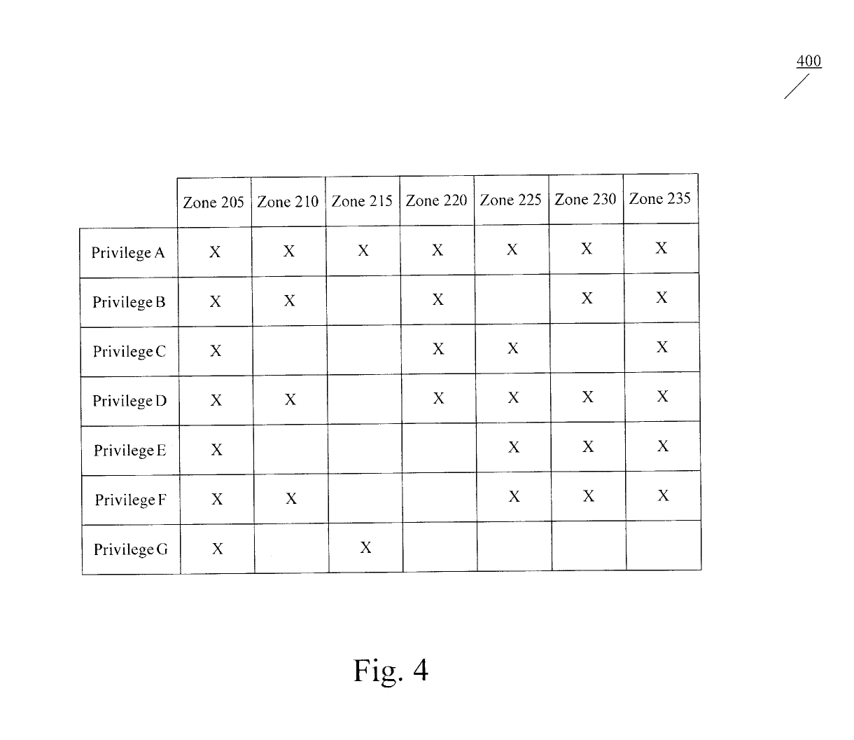

FIG. 4 shows a spreadsheet 400 for an ACL depending a zone according to an exemplary embodiment of the present invention. Specifically, the spreadsheet 400 illustrates a plurality of different privileges A-G for the zones 205-235 of the network 200 of FIG. 2. The spreadsheet 400 may be adjustable by an administrator of the ACL engine 130. That is, the spreadsheet 400 may represent an input screen for the ACL engine 130. The spreadsheet 400 will be discussed with reference to the network 200 of FIG. 2 and the method 300 of FIG. 3.

As discussed above, the method 300 provides exemplary steps of granting privileges based on location. The network 200 illustrates that the MU 160 is disposed in zone 210. Thus, the location engine may determine the location of the MU 160 (step 305) and ascertain that the MU is in zone 210 (step 310). The switch 205 may determine that in zone 210, the MU 160 is granted privileges A, B, D, and F. If the MU 160 moves to zone 215 (step 315), the switch may again determine the location (step 305) and the zone (step 310) of the MU. The switch 205 may again reference the spreadsheet 400 to determine that the MU is granted privileges A and F (steps 320, 325). Thus, granting of privileges B, D, and F have been removed. The iteration of the method 400 may continually reference the spreadsheet 400 to determine the privileges. It should be noted that the zone 205 may be granted all the privileges A-F. That is, because the zone 205 includes the switch 205, the zone 205 may be an administrative office.

In a further example, the ACL may have multiple dimensions. For example, there may be a first MU type that is used by employees and a second MU type that is used by customers. Thus, the ACL may include privileges that are granted based on zones and MU type. Those skilled in the art will understand that privileges may be granted based on location and any number of further criteria.

Those skilled in the art will also understand that the location engine 135 and the ACL engine 130 may be located anywhere within the network and do not need to be located on the switch 100. For example, these components/processes may be located on a network server, a network appliance, an AP, etc. In fact, the present invention may be implemented on a network that does not include a switch. Thus, the components/processes would need to be located in a different network component.

Those skilled in the art will understand that the above described exemplary embodiments may be implemented in any number of manners, including, as a separate software module, as a combination of hardware and software, etc. For example, the ACL engine 130 and the location engine 135 may be a program containing lines of code that, when compiled, may be executed on the processor 110.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A method, comprising:
determining a location of a mobile unit disposed within a coverage area of a network, the coverage area being separated into a plurality of zones;
determining a first zone in which the mobile unit is disposed; and
granting access to a first privilege to the mobile unit, the first privilege being based on the first zone.

2. The method of claim 1, further comprising:
associating the first privilege with the first zone.

3. The method of claim 1, wherein the network is disposed in a facility.

4. The method of claim 1, wherein the network includes a switch.

5. The method of claim 4, wherein the switch includes a location engine that is used to determine the location and an access control list engine that includes an access control list controlling a granting of the first privilege.

6. The method of claim 4, wherein the switch grants the first privilege to the mobile unit.

7. The method of claim 1, further comprising:
determining if the mobile unit has moved into a second zone; and
granting access to a second privilege to the mobile unit, the second privilege being based on the second zone.

8. The method of claim 7, further comprising:
upon moving to the second zone, denying access to the first privilege of the first zone.

9. The method of claim 1, wherein the location is determined using at least one of a global positioning system, received signal strength indication, smart surroundings, and a radio frequency identification.

10. The method of claim 3, wherein the facility is one of a warehouse, an office, and a retail environment.

11. A system, comprising:
a wireless switch including an access control list and a location engine;
a plurality of access points located in a facility and communicating with the wireless switch, the facility being separated into a plurality of zones; and
at least one mobile unit disposed within a first zone of the facility, the mobile unit being granted access to a first privilege based on the first zone, the first privilege being determined by the access control list and the location engine, the access control list controlling a granting of the at least one privilege, the location engine determining the location of the mobile unit and associating the first privilege with the first zone.

12. The system of claim 11, wherein the location engine determines if the mobile unit has moved into a second zone.

13. The system of claim 12, wherein the access control list indicates that the mobile unit is granted access to a second privilege of the second zone.

14. The system of claim 12, wherein the access control list indicates that the mobile unit is denied access to the first privilege of the first zone.

15. The system of claim 11, wherein the location engine determines the location using at least one of a global positioning system, received signal strength indication, smart surroundings, and a radio frequency identification.

16. The system of claim 11, wherein the facility is one of a warehouse, an office, and a retail environment.

17. A device disposed within a network for a facility, the facility being separated into a plurality of zones, the device comprising:
an access control list engine including an access control list controlling a granting of at least one privilege to the mobile unit; and
a location engine determining a location of the mobile unit and associating the at least one privilege with one of the plurality of zones.

18. The device of claim 17, wherein the mobile unit is granted a first set of privileges based on a first zone.

19. The device of claim 18, wherein the mobile unit is denied the first set of privileges when moving into a second zone and is granted a second set of privileges based on the second zone.

20. The device of claim 17, wherein the facility is one of a warehouse, an office, and a retail environment.

21. A computer readable storage medium including a set of instructions executable by a processor, the set of instructions operable to:
determine a location of a mobile unit disposed within a coverage area of a network, the coverage area being separated into a plurality of zones;
determine a first zone in which the mobile unit is disposed; and
grant access to a first privilege to the mobile unit, the first privilege being based on the first zone.

22. A device disposed within a network for a facility, the facility being separated into a plurality of zones, the device comprising:
an control means for granting at least one privilege to the mobile unit; and
a locating means for determining a location of the mobile unit and associating the at least one privilege with one of the plurality of zones.
